(19) United States
(12) Patent Application Publication
(10) Pub. No.: US 2008/0098906 A1
(43) Pub. Date: May 1, 2008

(54) Double door smoker

(76) Inventor: Mark E. Davis, Midland, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/586,389

(22) Filed: Oct. 25, 2006

(51) Int. Cl. A23B 4/044

(52) U.S. Cl. 99/482

(57) ABSTRACT

A smoker for use in cooking food having a firebox and a smoking chamber connected together in a heating relationship for providing heat and smoke to the smoking chamber, at least one openable access door and at least one removeable divider covering an opening in the smoking chamber for sealing the chamber and providing access thereto.

### FIELD OF THE INVENTION

The present invention generally relates to outdoor smokers.

### DESCRIPTION OF THE RELATED ART

Related art is in the field of devices having a firebox and a smoking chamber for cooking and smoking food using the heat and smoke from the firebox.

### BACKGROUND OF THE INVENTION

With traditional offset smokers, the smoking chamber door is configured to run the entire length of the smoking chamber. In order to access the contents of the smoking chamber, the user must raise the smoking chamber lid, allowing much of the heat and smoke to escape. This can considerably lengthen cooking time and the lowered temperature may compromise certain foods.

Two or more smaller smoking chamber doors are desirable, or even a single door with a removable divider, as they would allow the user to open up only part of the smoking chamber, exposing less of the smoking chamber to heat and smoke loss.

There are three current methods used to build multi-door smoking chambers. The first method utilizes two doors that are aligned side by side, with one door overlapping the other to seal the joint between the doors. This method is effective at sealing the joint, but only allows one door (the top door) to be opened at a time.

The second method also utilizes two doors that are aligned side by side, but with the sealing joint between the doors created by each door overlapping a center divider that is permanently attached to the smoking chamber. This method is effective at sealing the joint, and allows both doors to open independently. However, the permanent center divider hinders access to the smoking chamber, particularly when trying to insert or remove large cuts of meat.

The third method again utilizes two doors that are aligned side by side, but the sealing joint between the doors simply relies on how close together the two doors fit side by side. This method allows both doors to operate independently, but is ineffective at sealing the joint.

Thus it can be seen that a need exists for a smoker which addresses the shortcomings of the prior art and provides more consistent cooking performance.

### SUMARY OF THE INVENTION

Disclosed is a method to allow for a multi-door smoking chamber, independently operating doors, adequate sealing properties in the joint between the doors, and full access to the smoking chamber to tend to large cuts of meats, etc. This is accomplished by utilizing one or more removable dividers. The doors seal over the outside surface of the removable divider, and therefore can be operated independently. The sealing surface of the removable divider is on the same level as that of the remaining peripheral sealing edges, resulting in a tight, consistent seal. There is a handle built into the removable divider to more easily facilitate its removal.

In addition, included is a cooking rack that removably attaches to the inside surface of the removable divider. This cooking rack provides additional and/or uniquely configured cooking space, as well as a provision for a water pan. This cooking rack can be easily removed from the smoking chamber by utilizing the handle of the removable divider.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an embodiment of a smoker;

FIG. 2 is a partial exploded perspective view, illustrating the divider and attached cooking rack in a removed position;

FIG. 3 is an exploded perspective view illustrating the divider separated from the cooking rack;

FIG. 4 is a partial perspective view showing the divider and cooking rack in position for operation;

FIG. 4A is a partial perspective view illustrating the connection of the divider to the top of the smoking chamber, the view being taken from circle 4A in FIG. 4;

FIG. 4B is a partial perspective view illustrating the connection of the bottom of the divider to the smoker chamber, taken from circle 4B in FIG. 4;

FIG. 5A is a partial cross sectional view, taken along line 5A-5A of FIG. 1; and

FIG. 5B is a partial cross sectional view, taken along line 5B-5B of FIG. 1.

### DETAILED DESCRIPTION

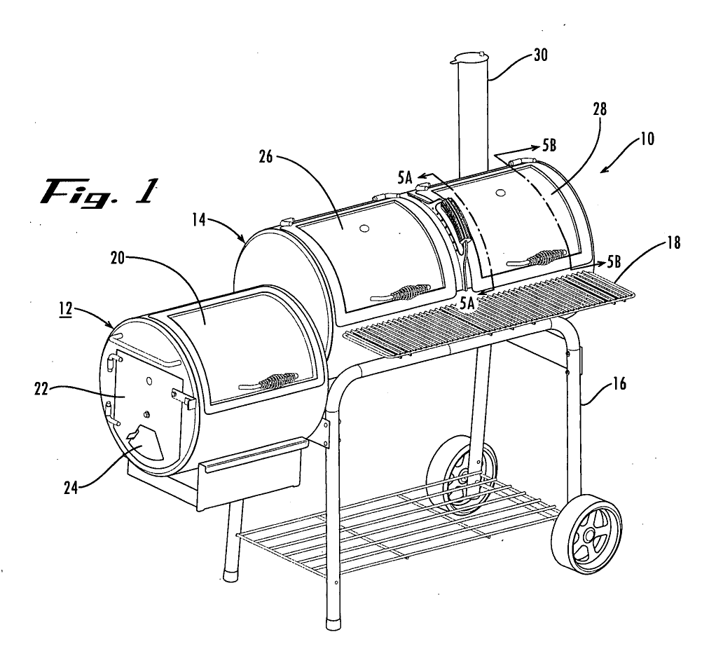

Referring now more specifically to the drawings and to FIG. 1 in particular, numeral 10 designates generally, an embodiment of a double door smoker. The smoker includes a firebox, designated generally as 12, and a smoking chamber designated generally as 14. The smoker may be mounted on a cart 16 or it can be mounted on a permanent fixture such as a post (not shown). A front shelf 18 may be provided for use in placing plates, utensils, condiments, etc.

The firebox 12 includes a front access door 20 and a side access door 22, both of which may be used for adding fuel, adjusting the fire inside, or cleaning out the firebox when cooking is finished and the coals have been extinguished. The side access door includes a damper 24 which can be opened or closed to alter the rate of combustion within the firebox.

The smoking chamber 14 includes a pair of doors, left chamber door 26 and right chamber door 28, as viewed from the front of the unit. The description from this point will address, for the sake of convenience, an embodiment as having two doors with a divider located therebetween. However, it is contemplated that other numbers of doors may be used with corresponding dividers disposed between the doors to accomplish the features of full or partial access to the smoking chamber. It is also further contemplated that a divider could be used with a single door, with full access provided by opening the door and removing the divider, or leaving one or the other in place. In this embodiment, the sealing surfaces, as described later, would be adjusted to correspond to the wall of the smoking chamber and the door. Such alternative embodiments are considered to be within the scope of the appended claims.

The smoking chamber also includes a chimney 30 by which the smoke in the chamber may be evacuated. In an operation typical of such smokers, smoke and heat from the firebox 12 enter the smoking chamber 14 through corresponding openings in the adjacent walls of the firebox and smoking chamber (not shown). The smoke and heat enter the smoking chamber, slowly cook and smoke the food products therein, and then exit through the chimney 30. As the food products are not in contact with direct heat such as in a barbecue grill, cooking is generally slow and may take several hours. Once the fire is built, the food is placed in the smoking chamber, and the rate of combustion is adjusted to a desirable level. The units are typically left alone for periods ranging from a relatively few minutes to several hours, dependent on the food being cooked.

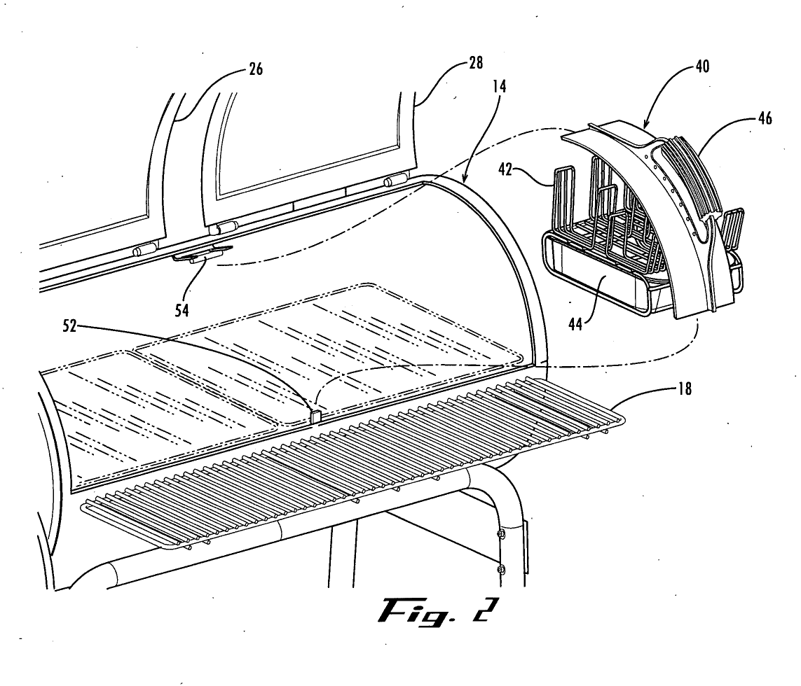

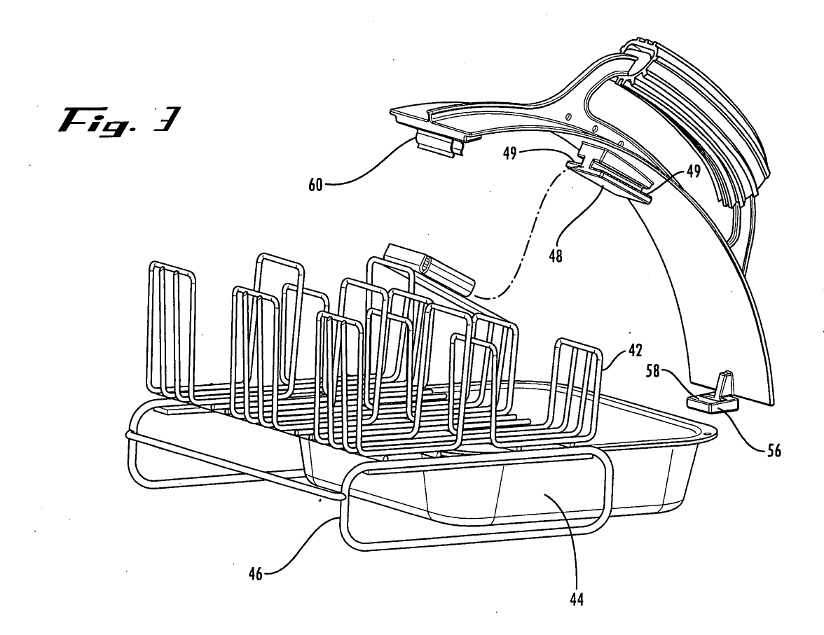

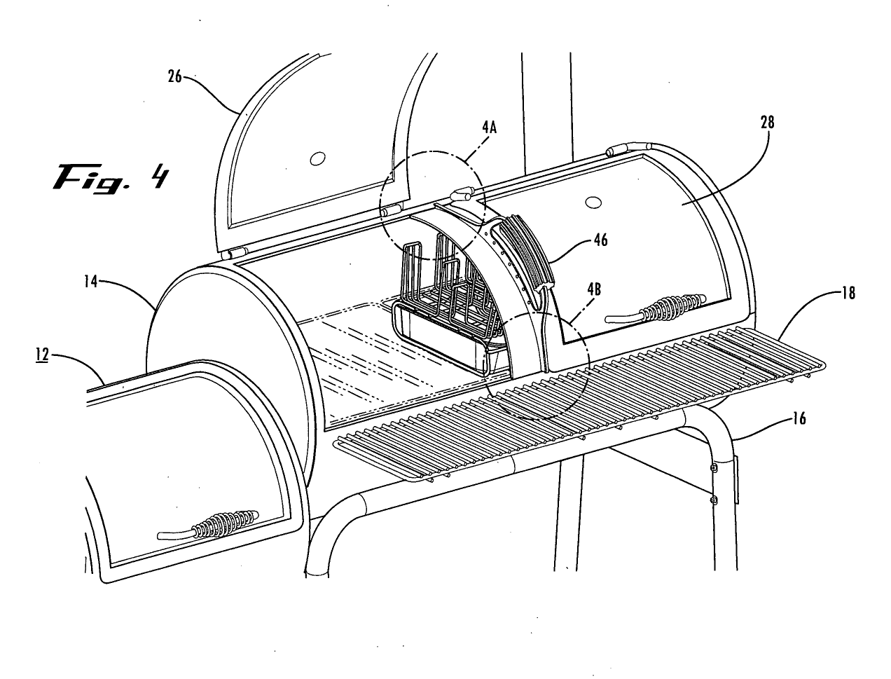

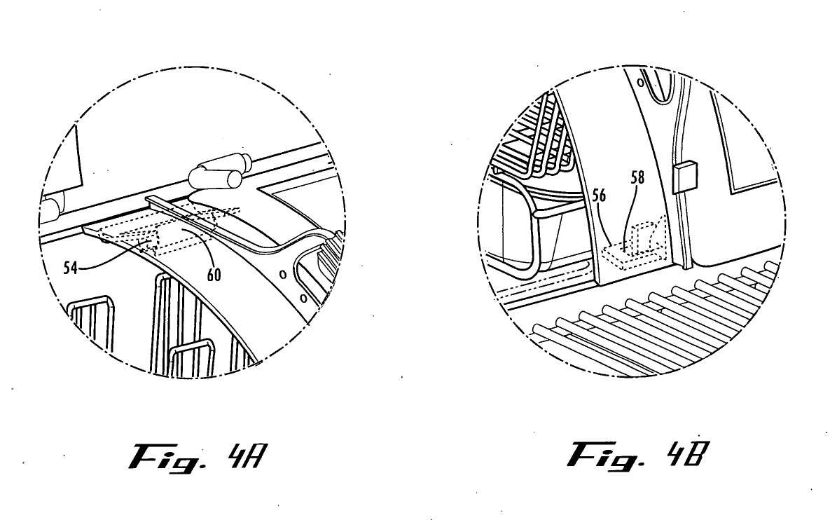

Referring to FIG. 2, the smoking chamber 14 is shown with both right and left chamber doors 26 and 28, respectively, in an open position. The doors are shown approximately the same size; however, one or the other could be larger and the other correspondingly smaller. Disposed between the doors is a divider 40 which is shaped to correspond to the shape of the smoking chamber and the doors, in this case, a circular element. It will be understood by those who are skilled in the art that various other shapes may be employed for constructing both the firebox and the smoking chamber; however, the shape shown in the drawings has attained particular significance as an item produced first by New Braunfels Smoker Company and now by it's successor, the present assignee, Char-Broil LLC. Divider 40 is removable as depicted in FIG. 2, and can be secured in place for operation of the smoker as shown in FIGS. 1 and 4. Also shown attached to the divider 40 in FIGS. 2 and 4 is a rack 42 which may be used for smoking ribs or holding vegetables and a drip pan 44 which is secured to the rack by sliding the pan into the lower framework 46 of the rack as shown in FIG. 3.

The divider 40 further includes a handle on the outer surface thereof which is used to manipulate the divider into and out of place on the outside of the smoking chamber and also to manipulate the securement of the handle to the rib rack and its associated drip pan. In an embodiment having three access doors (not shown), two removable dividers would be used, permitting full or partial access as needed. More than three doors are also possible, with dividers to separate the doors and help seal the smoking chamber, and being capable of removal and replacement.

Referring to FIG. 3, a clip 48 having grooves 49 forming a tongue is insertable into a receiving bracket 50, thereby securing the rib rack and pan in place beneath the divider where it can be manipulated into or out of position without the possibility of the rack being dislodged when loaded with food.

As noted, FIG. 2 illustrates a smoker with both doors opened and the divider removed. FIG. 4 illustrates the smoker with one door open, one door closed, and the divider in place. With the slow cooking operation of the smoker, which occurs at lower temperatures than occur in a barbecue grill, minimization of heat loss is important both to keep the cooking time relatively short, and to thoroughly cook the food. Thus, once the cooking operation has begun, it is important to minimize heat loss as much as possible while still allowing access to the food for operations such as basting, turning, etc. As can now be appreciated, the smoker as thus far described, allows for the opening of only one chamber door for basting or turning the food that is relatively small or allows the opening of both doors for access to virtually the entire smoking chamber for basting or turning large items such as, for example, a side of beef. This versatility is not present in the prior art and offers many advantages for increasing the use and usefulness of smokers such as that shown in the drawings here.

Details of the securement of the divider to the smoking chamber are shown in FIGS. 2 and 4A and B. In FIG. 2, tab 52 and rod 54 are secured to the bottom and the top of the smoking chamber respectively, situated in the area between the left and right chamber doors. Mounted on the bottom of the divider 40 is a mounting bracket 56 with a slot 58 that is placed over tab 52 to secure the bottom of the divider to the smoking chamber. Secured to the top of the divider is a spring clip 60 that is snapped over rod 54 as shown in FIG. 4A to secure the top of the divider to the smoking chamber. Removal of the divider is essentially a reversal of the attachment procedure, i.e., the top of the divider is first disengaged from its mounted position by lifting the spring clip off of the rod and the divider is then lifted upwardly to disengage the slot from the tab 56 at the bottom of the divider.

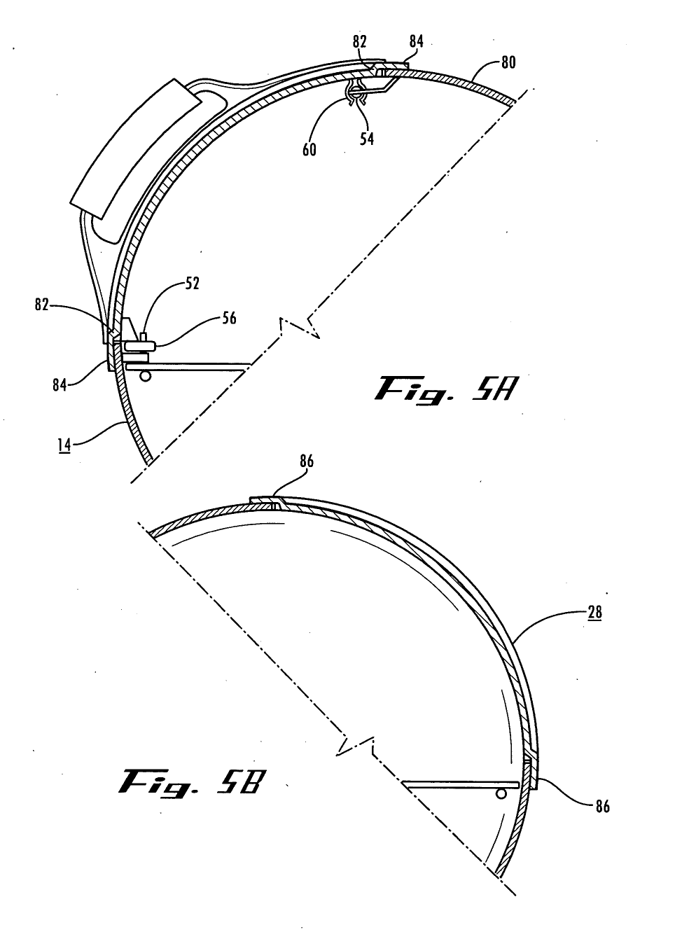

It is noted that in a slow cooking operation it is important to conserve heat both for efficiency and for thorough cooking. FIGS. 5A and 5B illustrate how the right and left chamber doors are sealed against the divider and against the outer edges of the chamber access. In FIG. 5A, the cross section is taken from the right chamber door, looking toward the divider 40. The divider 40 overlaps the outer chamber wall 80 at the top and the bottom. This is accomplished by the use of a slight offset at the top and bottom of the divider so that the main portion of the divider is essentially the same shape or, in this case, diameter as that of the outer chamber wall. The offset 82 forms a lip 84 at both the top and bottom of the divider that rests against the outer wall 80 of the chamber, creating a sealing interface.

Similar offsets are formed in the right and left chamber doors as illustrated by FIG. 5B. FIG. 5B is taken with a view toward the outside of the right chamber door, illustrating the overlapping lip 86 that is formed around the left and right chamber doors for purposes of creating a sealing interface. This lip 86 overlaps the outer edges of the chamber wall that frame the opening in the chamber as well as the divider 40 for creating a sealing interface between the doors, the chamber wall, and the divider.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

I claim:

1. A smoker for use in cooking comprising a firebox and a smoking chamber with an access opening, said smoking chamber having at least two doors positioned in said access opening for accessing the interior of said smoking chamber, and a removable divider positioned between said two doors in said access opening.

2. A smoker as defined in claim 1 in which said divider has a sealing interface for minimizing heat loss between said divider and said doors.

3. A smoker as defined in claim 1 in which said doors have sealing interfaces for minimizing heat loss between said doors and said divider.

4. A smoker as defined in claim 3 in which said sealing interfaces comprise overlapping lips for engaging said divider.

5. A smoker grill comprising a firebox and a smoking chamber connected thereto in heating relationship for providing heat and smoke from said firebox to said smoking chamber, said chamber having an access opening for inserting and removing items to be cooked therein, a plurality of access doors disposed to cover and access said opening, and a plurality of removable dividers disposed between said doors to complement said doors in covering said opening.

6. A smoker grill as defined in claim 5 in which said divider has a sealing interface for minimizing heat loss between said divider and said doors.

7. A smoker grill as defined in claim 5 in which said doors have sealing interfaces for minimizing heat loss between said doors and said divider.

8. A smoker comprising a firebox and a smoking chamber with an access opening for receiving and removing food to be cooked therein, at least one door disposed over said opening for closing said opening and providing access to said smoking chamber, and a removeable divider disposed over said opening for closing said opening and providing access to said smoking chamber in combination with said door.

9. A smoker as defined in claim 8 in which said divider has a sealing interface for minimizing heat loss between said divider and said doors.

10. A smoker as defined in claim 8 in which said doors have sealing interfaces for minimizing heat loss between said doors and said divider.
